(19) United States
(12) Patent Application Publication
(10) Pub. No.: US 2004/0182852 A1
(43) Pub. Date: Sep. 23, 2004

(54) Circuit arrangement for inductively operating sensor and method for the operation thereof

(75) Inventors: Gerd Knappe, Bretten (DE); Wilhelm Perrin, Karlsruhe (DE)

Correspondence Address: AKERMAN SENTERFITT, P.O. BOX 3188, WEST PALM BEACH, FL, 33402-3188, US

(73) Assignee: E.G.O. Elektro-Geraetebau GmbH, Oberderdingen (DE)

(21) Appl. No.: 10/767,562

(22) Filed: Jan. 29, 2004

(30) Foreign Application Priority Data
Feb. 6, 2003 (DE) 103 05 788.9

(51) Int. Cl. H05B 1/02

(52) U.S. Cl. 219/518; 219/519; 219/506

(57) ABSTRACT

In the case of a circuit for several inductive pot or saucepan detection coils a control and evaluation circuit is provided. Using switches in the form of MOSFETs, the control or evaluating circuit is in each case connected to one coil in multiplex operation. The MOSFETs have a low drain-source resistance in order to avoid off-resonancing of resonant circuit frequencies due to the overcoupling of several leads to the coils.

### FIELD OF APPLICATION AND PRIOR ART

The invention relates to a circuit arrangement for several inductively operating sensors, as well as to a method for the operation thereof.

Pot or saucepan detection systems are known which use inductively operating sensors or so-called PD/SD sensors. Such SD sensors together with the control means are described in EP 442 275 A1 and EP 469189 A1. Also in the afore-mentioned prior art, the control of such SD sensors is relatively complicated, which has prevented a more widespread use of such SD sensors for example in cooking zones.

In many cases the frequency change in a SD system on setting down a saucepan is approximately 3 to 5%. If the resonant circuit frequency is displaced by roughly this range through overcoupling, a clear and safe saucepan detection is no longer ensured.

It is an object of the invention to provide a circuit arrangement of the afore-mentioned type and a method for the operation thereof, which are able to avoid the problems of the prior art and which can in particular reduce the costs for controlling SD sensors, particularly for controlling several SD sensors with a single circuit arrangement.

This object is achieved by a circuit arrangement having the features of claim 1. Advantageous and preferred developments of the invention form the subject matter of further claims and are explained further hereinafter. By express reference the wording of the claims is made into part of the content of the description.

According to the invention a circuit arrangement for inductively operating sensors has control means and evaluating means for the sensors, as well as the associated sensor signals. By means of electronic switching means, the control means and the evaluating means are connected in each case to one sensor, virtually in the manner of a multiplex operation. According to the invention the switching means is constituted by a MOSFET, which has a low drain-source resistance.

Within the framework of the invention it has been shown that through the use of a MOSFET with such a low drain-source resistance, it is possible to reduce or even completely avoid overcoupling between leads to different sensors. This greatly improves the operation of such sensors, for example in SD systems. Here a high detection reliability is required, because otherwise when no saucepan is placed on a cooking point, the latter does not operate and this is unacceptable to the user. In addition, after removing a saucepan from a cooking point this must be detected and said point switched off, because otherwise operation is continued under no-load conditions. This wastes energy and gives rise to an accident risk. In addition, an EMC test can be better handled by a switching means or MOSFET according to the invention.

According to a further development of the invention, for each sensor there is precisely one switching means, which improves the controllability of the individual sensors.

The circuit arrangement can have resonant circuit capacitors, which are connected parallel to a saucepan or pot detection sensor for the operation thereof. This makes it advantageously possible to only provide a single resonant circuit capacitor, which, by means of the switching means, is in each case connected parallel to a random sensor for producing a measuring frequency. This means that of a plurality of sensors in each case one sensor is connected to the resonant circuit capacitor by the switching means in order to produce the measuring frequency and simultaneously said sensor is evaluated. Thus, the resonant circuit capacitor is virtually included in the multiplex operation.

In a further development of the invention a second resonant circuit capacitor is connected parallel to the first resonant circuit capacitor. This makes it possible to produce a second measuring frequency. This makes it possible to better detect and avoid HF interference which can be prejudicial to saucepan detection. This is particularly the case if the HF interference does not have a constant, but instead a varying frequency and possibly both or all the measuring frequencies interfere at different times. Thus, it is always possible to very reliably detect the presence of a saucepan. There must be a certain difference between the different measuring frequencies, for example between approximately 5 and 10%.

The invention is advantageously used for SD sensors in a cooking zone. The sensors can advantageously be a wire loop with a few turns. Advantageously the sensor is inherently stable and can in particular be a single, stable wire loop. Such a SD sensor is disclosed in U.S. Pat. No. 5,893,996, whose content is by express reference made into part of the content of the present application.

In the case of a method according to the invention for the operation of the aforementioned circuit arrangement having the features of claim 6, the gate control voltage at the MOSFET can be readjusted. It is therefore possible to produce a frequency which is constant over varying temperatures. It is consequently possible to prevent varying ambient temperatures, for example also through the operation of heating devices of a cooking zone.

In the case of the aforementioned measurement with two measuring frequencies an averaging can take place over numerous measurements. By means thereof it is possible to calculate a probability as to whether an object which is to be detected by the sensor is present or whether a saucepan is present in the case of a SD sensor. For this purpose corresponding algorithms or probability values can be filed in a control means or an associated memory.

It is also possible to choose different first and second resonant circuit capacitors and various design possibilities are available.

These and further features of preferred developments of the invention can be gathered from the claims, description and drawings and the individual features, both singly or in the form of subcombinations, can be implemented in an embodiment of the invention and in other fields and can represent advantageous, independently protectable constructions for which protection is claimed here. The subdivision of the application into individual sections and the subheadings in no way restrict the general validity of the statements made thereunder.

### BRIEF DESCRIPTION OF THE DRAWING

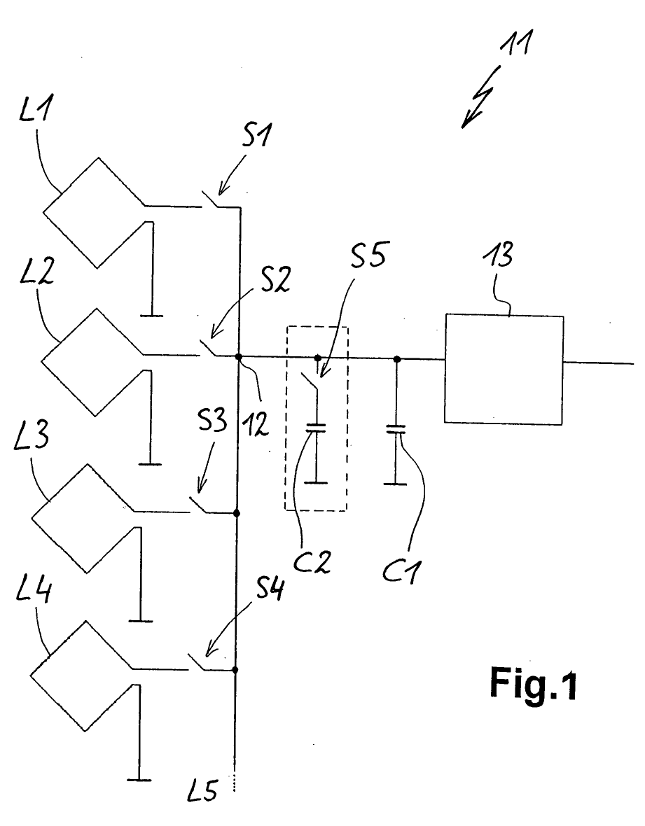

An embodiment of the invention is shown in the drawing and is explained in greater detail hereinafter, FIG. 1 showing in highly diagrammatic form a block circuit diagram with four PD or SD sensors, switching means and two resonant circuit capacitors.

### DETAILED DESCRIPTION OF THE EMBODIMENT

FIG. 1 shows a circuit arrangement 11, such as can for example be used for a SD system and which has four coils L1 to L4, but more can be provided. The coils L operate as SD sensors, as stated hereinbefore.

In each case the coils L1 to L4 are connected by means of a switch S1 to S4 to a common circuit node or junction 12, which is connected to a basic oscillator circuit 13 for producing the resonant circuit frequency. There is also a resonant circuit capacitor C1, which in each case together with a coil L forms a parallel resonant circuit of the inductance of the coil and the resonant circuit capacitance. In this way and in the manner of a multiplex operation, in each case one coil is connected by the corresponding switch S to the circuit junction 12. The other switches S are open and the corresponding coils L separated. The basic oscillator circuit 13 then emits a signal for a further evaluation of the resonant circuit frequency to establish whether it has changed in such a way as to enable the assumption to be made that a saucepan is detected by the sensor of coil L.

In the broken line area it is shown how a second resonant circuit capacitor C2 can be connected with a further switch S5 parallel to the first resonant circuit capacitor C1, as explained hereinbefore.

The switches S1 to S4 of the coils L and the switch S5 of the second resonant circuit capacitor C2 are controlled by means of a separate, not shown circuit for the aforementioned multiplex operation. As explained hereinbefore, the switches S1 to S4 for the coils L are MOSFETs. According to the invention, they have a low drain-source resistance.

The measuring frequency can be in a range of a few MHz, for example approximately 2.5 to 4 MHz.

1. A circuit arrangement with several inductively operating sensors, said circuit arrangement having switching means, control means for said sensors and evaluating means for signals generated by said sensors as a response to said control means and by means of said switching means said control means and said evaluating means are electrically connected to in each case one said sensor, wherein said switching means comprise a MOSFET with a low drain-source resistance.

2. The circuit arrangement according to claim 1, wherein there is provided precisely one switching means per sensor.

3. The circuit arrangement according to claim 1, wherein said circuit arrangement has resonant circuit capacitors, one said single resonant circuit capacitor being a first resonant circuit capacitor and being connectable by said switching means parallel to in each case all said sensors for producing a measuring frequency.

4. The circuit arrangement according to claim 3, wherein there is a second resonant circuit capacitor parallel to said first resonant circuit capacitor, and switches are provided in order to switch on and off said different resonant circuit capacitors.

5. The circuit arrangement according to claim 4, wherein switching on and off of said resonant circuit capacitors produces a difference of at least 8% between measuring frequencies.

6. The circuit arrangement according to claim 1, wherein said sensors are pot or saucepan detection sensors in a cooking zone.

7. The circuit arrangement according to claim 6, wherein said sensor is a wire loop having a few turns.

8. A method for operating a circuit arrangement with several inductively operating sensors, having switching means, control means for said sensors and evaluating means for signals, which are generated by said sensors as a response to said control means and by means of said switching means said control means and evaluating means are electrically connected to in each case one said sensor, said switching means being a MOSFET with a low drain-source resistance, wherein a gate control voltage at said MOSFET is readjusted so as to give a frequency which is constant with varying temperature.

9. The method according to claim 8, wherein operation takes place with two measuring frequencies.

10. The method according to claim 9, wherein by averaging over numerous measurements a probability is calculated and by means thereof it is established whether or not a saucepan is present.

11. The method according to claim 8, wherein two different capacitors are connected in parallel to one said sensor as resonant circuit capacitors and are operated with different measuring frequencies.
